(19) United States
(12) Patent Application Publication
(10) Pub. No.: US 2026/0167834 A1
(43) Pub. Date: Jun. 18, 2026

(54) COLORED PENCIL LEAD, GRAPHITE LEAD, COLORED OR GRAPHITE CHALK

(71) Applicant: Faber-Castell AG, Stein (DE)

(72) Inventors: Harald VON GODIN, Oberasbach (DE); Gerhard LUGERT, Nurnberg (DE)

(21) Appl. No.: 19/399,895

(22) Filed: Nov. 25, 2025

(30) Foreign Application Priority Data
Nov. 29, 2024 (EP) 24216637.9

(51) Int. Cl. C09D 11/16

(52) U.S. Cl. CPC C09D 11/16

(57) ABSTRACT

The invention relates to a colored pencil lead, graphite lead, colored or graphite chalk for painting and/or drawing, having a lead base mass that contains waxes, at least one filler and at least one colorant, wherein the lead base mass further contains aluminum distearate and, as waxes, at least one functionalized metallocene polyolefin wax and at least one hardened wax.

The invention relates to a colored pencil lead, a graphite lead, or a colored or graphite chalk for painting and/or drawing, having a lead base mass that contains waxes, at least one filler, at least one colorant and aluminum distearate.

From the prior art, water-resistant leads or chalks are known which are produced by means of an extrusion process from a lead base mass containing fats and/or waxes, fillers and color pigments, along with further additives if applicable.

EP 2 520 442 B1, for example, describes water-resistant leads that contain aluminum distearate, oxidized polyethylene wax and fatty-acid derivatives. These leads are indeed suitable for simple colored pencils, but they cannot be applied softly and exhibit low covering properties when forming a stroke on a drawing surface.

From EP 3 772 532 B1, water-resistant leads are known that contain oxidized ethylene-vinyl acetate wax (EVA) and at least one functionalized metallocene polyolefin wax. These colored pencil leads do show somewhat improved properties compared to the leads known from EP 2 520 442 B1 in terms of softness, but do not meet the expectations for very high-quality colored pencil leads, which are particularly desired for artists' pencils and other high-quality colored pencil leads.

It is therefore desirable to develop compositions for water-resistant colored pencil leads, graphite leads, and colored or graphite chalks that are softer to apply than the leads known from the prior art and that allow larger amounts of lead material to be deposited on the drawing surface (paper, cardboard or wood) during application. Furthermore, better coverage should be possible when painting over different colors without compromising mechanical properties such as breaking strength compared to the prior art.

It is therefore an object of the invention to provide colored pencil leads, graphite leads, colored or graphite chalks, in particular water-resistant colored pencil leads, graphite leads, colored or graphite chalks, for painting and/or drawing, which exhibit a soft application behavior along with an opaque stroke and can also be effectively produced by means of extrusion processes.

The object is achieved with a colored pencil lead, graphite lead, colored or graphite chalk, in particular a water-resistant colored pencil lead, graphite lead, colored or graphite chalk, for painting and/or drawing with the features according to claim 1. The colored pencil lead, graphite lead, colored or graphite chalk comprises a lead base mass containing waxes, at least one filler and at least one colorant. According to the invention, the lead base mass further contains aluminum distearate, and the waxes contain at least one functionalized metallocene polyolefin wax and at least one hardened wax, hardened oil or hardened fat. Thus, wax mixtures are also conceivable.

As a matter of simplification, the following will primarily refer to colored pencil leads or simply “leads.”

A large number of tests showed that a combination of aluminum distearate with functionalized metallocene polyolefin wax and hardened wax/hardened oil/hardened fat produces particularly soft-applying leads that also exhibit improved covering power compared with the described prior art. This was surprising, since combining constituents of the relatively hard and weakly coloring leads of EP 2 520 042 B1 with constituents of a lead according to EP 3 772 532 B1, which is improved but still not sufficiently soft, made it possible to develop a lead whose application properties are markedly improved compared with both prior-art documents cited.

The term, hardened waxes/oils/fats, refers to waxes, oils or fats that have undergone a “fat hardening” process. In this process, oils or low-melting waxes are hydrogenated and any double bonds present are saturated. As a result, on the one hand, the melting range of the “treated” wax/oil increases. In addition, the hydrogenated waxes “resinify” significantly less than non-hydrogenated waxes.

For the property profile of the lead, it has proven sufficient for the aluminum distearate to be present in the lead base mass at a proportion of 0.4 to 10.0 wt. %.

The functionalized metallocene polyolefin wax is preferably present in the lead base mass at a proportion of 5.0 to 25.0 wt. %.

The at least one functionalized metallocene polyolefin wax preferably has a drop point between 120 and 160° C. (ISO 2176) and an acid number between 16 and 50 mg KOH/g (ISO 2114).

In particular, ethylene-maleic anhydride copolymer (CAS No. 9006-26-2) or propylene-maleic anhydride copolymer (CAS No. 25722-45-6) is contained as functionalized metallocene polyolefin wax. Such functionalized metallocene polyolefin waxes are available, for example, under the trade names Licocene PP MA 6252²⁾ (drop point: 137-142° C.; acid number: 38-45 mg KOH/g), Licocene PE MA 4221²⁾ (drop point: 120-126° C.; acid number: 16-20 mg KOH/g), and Licocene PE MA 4351²⁾ (drop point: 120-126° C.; acid number: 42-49 mg KOH/g).

The hardened wax or hardened wax mixture preferably has a drop point between 50 and 120° C. (ISO 2176) and an acid number between 1 and 11 mg KOH/g (ISO 2114).

According to preferred embodiments, the hardened waxes, hardened oils or hardened fats are selected from palm wax, rapeseed wax, sunflower wax, soy wax, ester wax, synthetic beeswax, montan wax, paraffin wax, natural waxes, carnauba wax and/or hydrogenated castor oil, but also include hardened vegetable triglycerides having wax-like structures based on the waxes listed. It is also conceivable to admix non-hardened waxes. Such a hardened wax is available, for example, under the trade name Polycerin 9548 ¹⁾ (drop point: 65-72° C.; acid number: max. 3 mg KOH/g). Further examples include the waxes available under the trade names Polycerin 9542 ¹⁾ (drop point: 68-72° C.; acid number: max. 3 mg KOH/g) and Polycerin RD ¹⁾ (drop point: 55-61° C.; acid number: max. 3 mg KOH/g).

The hardened wax or hardened wax mixture is preferably contained in the lead base mass at a proportion of 2.0 to 30.0 wt. %.

A proportion of the colored pencil lead, graphite lead, colored or graphite chalk is formed by at least one filler, wherein the use of the at least one filler at a proportion of 5.0 to 80 wt. % in the lead base mass has proven to be advantageous.

Inorganic, finely powdered fillers, in particular talc, pumice powder, kaolin, mica, aluminum silicate, clay and/or calcium carbonate, are particularly suitable as fillers, since, due to their polarity, they are bound particularly well in the lead base mass.

The lead base mass contains, in particular, at least one dye and/or at least one inorganic pigment and/or at least one organic pigment as the colorant, inorganic and/or organic pigments being preferred over dyes. For example, the inorganic pigments include titanium dioxide, manganese violet, ultramarine, ferric ferrocyanide, iron oxides, carbon black or metallic pigments, e.g., aluminum. Organic pigments are preferably selected from the group of phthalocyanine, azo, quinacridone, isoindoline and diketopyrrolopyrrole pigments.

As an advantageous use concentration for the at least one colorant, a proportion of 0.1-50 wt. %, in particular a proportion of 0.1-40 wt. % and most preferably a proportion of 0.1-30 wt. % in the lead base mass has proven suitable.

Finally, it is also advantageous if the lead base mass contains at least one additive, in particular a lubricant and/or a dispersing agent, e.g., CAS 85711-47-3, CAS 108-31-6, CAS 398475-96-2, CAS 57472-68-1, CAS 14431-03-8. Examples of lubricants that can be used here include salts of fatty acids such as calcium stearate, magnesium stearate, zinc stearate, sodium stearate or magnesium myristate.

Preferably, the proportion of the additive in the lead base mass is limited to a maximum of 5.0 wt. %.

The colored pencil leads are water-resistant and can be produced in a two-stage process. The raw materials of the lead, or the constituents of the lead base mass, can be mixed and extruded at relatively low temperatures of about 110 to 140° C. This results in softening of the two waxes to a consistency that allows lead strands having a diameter of 3 to 5 mm for colored pencil leads and up to 20 mm for colored chalks to be extruded, despite the fillers and color pigments also contained therein.

The colored pencil lead is thus produced from a lead base mass or starting lead mass containing the aforementioned components or starting materials, which is processed thermoplastically and extruded in order to melt and bind the starting materials. The resulting lead strands are subsequently cut to length if applicable. Once the lead mass has cooled, the finished lead is already present, and no elaborate removal of water is required.

In summary, the following basic formulation can be specified for the colored pencil lead, graphite lead, or colored or graphite chalk according to the invention:

| | | |
|---|---|---|
| Aluminum distearate | 0.4-10.0 | wt. % |
| Functionalized metallocene polyolefin wax | 5.0-25.0 | wt. % |
| Hardened wax/wax mixture | 2.0-30.0 | wt. % |
| Filler | 5.0-80.0 | wt. % |
| Colorant | 0.1-50 | wt. % |
| Additives | Up to 5.0 | wt. % |

Six example formulations are listed below. The FIGURES in the example formulations, given in weight percent, in each case refer to the proportions in the lead base mass. The production of the leads or chalks takes place in a two-stage process. Initially, the raw materials are mixed and homogenized in highspeed mixers, kneaders or compounding extruders at mixing temperatures of 110-140° C. After mixing, cooling the homogeneous mass yields a solid granulate at room temperature; if necessary, additional mechanical crushing is carried out. The granulate obtained in this way is subsequently fed to an extruder, for example a screw extruder, and the shaping of the leads or chalks takes place in the screw extruders at temperatures of 130-140° C. The lead base mass is extruded into lead strands, which are subsequently cut to length.

### EXAMPLE 1A

Example formulation for a blue colored pencil lead having a diameter of 4.0 mm:

| | | |
|---|---|---|
| Aluminum distearate (CAS no. 300-92-5) | 1.2 | wt. % |
| Ethylene-maleic anhydride copolymer | | |
| (CAS no. 9006-26-2) | 9.5 | wt. % |
| Hard vegetable wax Polycerin 9548¹⁾ | 12.3 | wt. % |
| Mica | 15.0 | wt. % |
| Kaolin | 57.0 | wt. % |
| Blue pigment 15:1, CI 74160 | 5.0 | wt. % |

### EXAMPLE 1B

Example formulation for a red colored pencil lead having a diameter of 4.0 mm:

| | | |
|---|---|---|
| Aluminum distearate (CAS no. 300-92-5) | 1.1 | wt. % |
| Ethylene-maleic anhydride copolymer | | |
| (CAS no. 9006-26-2) | 9.1 | wt. % |
| Hard vegetable wax Polycerin 9548¹⁾ | 11.8 | wt. % |
| Mica | 15.0 | wt. % |
| Kaolin | 58.0 | wt. % |
| Red pigment 254, CI 56110 | 5.0 | wt. % |

### EXAMPLE 1C

Example formulation for green chalk having a diameter of 12.0 mm:

| | | |
|---|---|---|
| Aluminum distearate (CAS no. 300-92-5) | 3.0 | wt. % |
| Ethylene-maleic anhydride copolymer | 15.0 | wt. % |
| (CAS no. 9006-26-2) | | |
| Hard vegetable wax Polycerin 9548¹⁾ | 25.0 | wt. % |
| Talc | 50.0 | wt. % |
| Calcium stearate | 4.0 | wt. % |
| Green pigment 7, CI 74260 | 3.0 | wt. % |

### EXAMPLE 1D

Example formulation for a yellow colored pencil lead having a diameter of 3.3 mm:

| | | |
|---|---|---|
| Aluminum distearate (CAS no. 300-92-5) | 5.0 | wt. % |
| Propylene-maleic anhydride copolymer | | |
| (CAS no. 25722-45-6) | 16.0 | wt. % |
| Hard vegetable wax Polycerin 9542¹⁾ | 30.0 | wt. % |
| Kaolin | 28.0 | wt. % |
| Magnesium myristate | 4.0 | wt. % |
| Dispersing agent BYK Dispersplast 1142²⁾ | 2.0 | wt. % |
| Yellow pigment 42, CI 77492 | 15.0 | wt. % |

### EXAMPLE 1E

Example formulation for a yellow colored pencil having a diameter of 3.8 mm:

| | | |
|---|---|---|
| Aluminum distearate (CAS no. 300-92-5) | 4.5 | wt. % |
| Ethylene-maleic anhydride copolymer | | |
| (CAS no. 9006-26-2) | 15.0 | wt. % |
| Hard vegetable wax Polycerin 9548¹⁾ | 3.0 | wt. % |
| Titanium dioxide | 8.0 | wt. % |
| Kaolin | 62.5 | wt. % |
| Yellow pigment 185, CI 56290 | 7.0 | wt. % |

### EXAMPLE 1F

Example formulation for a graphite lead having a diameter of 3.0 mm:

| | | |
|---|---|---|
| Aluminum distearate (CAS no. 300-92-5) | 7.0 | wt. % |
| Ethylene-maleic anhydride copolymer | | |
| (CAS no. 9006-26-2) | 20.0 | wt. % |
| Hard vegetable wax Polycerin RD 828¹⁾ | 15.0 | wt. % |
| Graphite powder | 18.0 | wt. % |
| Clay | 40.0 | wt. % |

In order to demonstrate the improvements achieved by the leads according to the invention over the cited prior art, comparative tests were carried out using leads according to EP 2 520 442 B1, i.e., leads without functionalized metallocene polyolefin wax, and leads according to EP 3 772 532 B1, i.e., leads without aluminum distearate. The comparative formulations are listed below:

### COMPARATIVE EXAMPLE 2A

Comparative formulation 2A according to EP 3 772 532 B1 for a blue colored pencil lead having a diameter of 4.0 mm:

### Ethylene-Maleic Anhydride Copolymer

| | | |
|---|---|---|
| (CAS 9006-26-2) | 9.5 | wt % |
| Oxidized ethylene vinyl acetate (EVA) wax | | |
| (CAS 104912-80-3) | 1.2 | wt % |
| Hard vegetable wax Polycerin 9548 ¹⁾ | 12.3 | wt % |
| Mica | 15.0 | wt % |
| Kaolin | 57.0 | wt % |
| Blue pigment 15:1; CI 74160 | 5.0 | wt % |

### COMPARATIVE EXAMPLE 2B

Comparative formulation 2B according to EP 3 772 532 B1 for a red colored pencil lead having a diameter of 4.0 mm:

### Ethylene-Maleic Anhydride Copolymer

| | | |
|---|---|---|
| (CAS 9006-26-2) | 9.1 | wt % |
| Oxidized ethylene vinyl acetate (EVA) wax | | |
| (CAS 104912-80-3) | 1.1 | wt % |
| Hard vegetable wax Polycerin 9548 ¹⁾ | 11.8 | wt % |
| Mica | 15.0 | wt % |
| Kaolin | 58.0 | wt % |
| Red pigment Red 254; CI 56110 | 5.0 | wt % |

### COMPARATIVE EXAMPLE 3A

Comparative formulation 3A according to EP 2 520 442 B1 for a blue colored pencil lead having a diameter of 4.0 mm:

| | | |
|---|---|---|
| Aluminum distearate (CAS 300-92-5) | 1.2 | wt % |
| Polyethylene wax having oxygen-containing | 9.5 | wt % |
| functional groups (CAS 68441-17-8) | | |
| Hard vegetable wax Polycerin 9548 ¹⁾ | 12.3 | wt % |
| Mica | 15.0 | wt % |
| Kaolin | 57.0 | wt % |
| Blue pigment 15:1; CI 74160 | 5.0 | wt % |

### COMPARATIVE EXAMPLE 3B

Comparative formulation 3B according to EP 2 520 442 B1 for a red colored pencil lead having a diameter of 4.0 mm:

| | | |
|---|---|---|
| Aluminum distearate (CAS 300-92-5) | 1.1 | wt % |
| Polyethylene wax having oxygen-containing | | |
| functional groups (CAS 68441-17-8) | 9.1 | wt % |
| Hard vegetable wax Polycerin 9548 ¹⁾ | 11.8 | wt % |
| Mica | 15.0 | wt % |
| Kaolin | 58.0 | wt % |
| Red pigment Red 254; CI 56110 | 5.0 | wt % |

In order to make reproducible application of the leads to paper possible, a device for lead application to paper was used. By means of this device, six color applications can be applied simultaneously and under comparable conditions to a drawing surface, in this case paper. For this purpose, the leads are held in holders, loaded with weight, and moved over the paper by means of the holder to produce the stroke.

### Test Procedure

In the machine used for applying graphite and colored pencil leads, test stations (fields) were available for six leads. An area of 20.25 cm² was applied per field, resulting in a total application area of 121.5 cm². The tested leads had a diameter of 4.0 mm, were sharpened, and a plateau of 1 mm² was created. Subsequently, the lead pieces were clamped into brass holders of the device and loaded with a total weight of 570 g per lead (holder 66 g+load weight 500 g+4 g lead weight). The machine applied six square areas (each 20.25 cm²), wherein the color application performed 10× from left to right and back.

The temperature during application was 21° C. (+/−1° C.), and the humidity was 50% relative humidity (+/−5%). A4 drawing pad paper, item no. 212046, Faber-Castell AG, D 90546 Stein bei Nürnberg, was used as the drawing surface.

### Results of the Comparative Tests

Initially, the leads according to formulations 1A and 1B according to the invention and according to the comparative formulations 2A, 2B, 3A and 3B were applied to the paper using the device shown.

Purely visually, a comparison of the variants according to 1A, 1B, 2A, 2B, 3A and 3B already showed that the lead strokes according to the invention of the formulations 1A and 1B were more color-intensive than the comparative strokes representing the prior art (2A, 2B, 3A, 3B).

The results are summarized in the following table, with higher color intensity indicated by a greater number of “+” signs:

TABLE 1

| | Lead according to | | Leads according to | | Leads according to | |
|---|---|---|---|---|---|---|
| | the invention | | EP 3 772 532 B1 | | EP 2 520 442 B1 | |
| | 1A | 1B | 2A | 2B | 3A | 3B |
| | (color | (color | (color | (color | (color | (color |
| | “Blue”) | “Red”) | “Blue”) | “Red”) | “Blue”) | “Red”) |
| Color | +++ | +++ | + | + | + | + |
| intensity | | | | | | |

By comparing the applied lead mass, an objective comparison can be demonstrated, as shown in the following table. In order to determine the applied lead mass, the paper was weighed before and after application of the lead in each case. The difference in weight then corresponds to the applied lead mass:

TABLE 2

| | Lead according to | | Leads according to | | Leads according to | |
|---|---|---|---|---|---|---|
| | the invention | | EP 3 772 532 B1 | | EP 2 520 442 B1 | |
| | 1A | 1B | 2A | 2B | 3A | 3B |
| | (color | (color | (color | (color | (color | (color |
| | “Blue”) | “Red”) | “Blue”) | “Red”) | “Blue”) | “Red”) |
| Applied | 107 mg | | 84 mg | | 99 mg | |
| lead mass | | | | | | |
| Applied | | 110 mg | | 77 mg | | 97 mg |
| lead mass | | | | | | |

| | | | |
|---|---|---|---|
| Σ (1A + | 217 mg | 161 mg | 197 mg |
| 1B) | | | |

Thus, higher amounts of lead mass can be applied to paper using the leads according to the invention. Thus, the leads according to the invention exhibit a softer application behavior.

In order to compare the covering power of the leads according to the invention with that of the cited prior art, the red leads were initially applied to the test fields and the blue leads were subsequently drawn over them.

By means of an optical comparison, it was possible to demonstrate that the leads according to the invention produce more homogeneous areas and also exhibit better covering power than the leads according to the cited prior art. Here as well, better homogeneity and/or better covering power is indicated by a higher number of “+”.

TABLE 3

| | Lead according to the | Leads according to EP 3 | Leads according to EP |
|---|---|---|---|
| | invention | 772 532 B1 | 2 520 442 B1 |
| | Initially, red leads 1B | Initially, red leads 2B | Initially, red leads 3B |
| | were applied. Then, blue | were applied. Then, blue | were applied. Then, |
| | leads 1A were drawn | leads 2A were drawn | blue leads 3A were |
| | over them. | over them. | drawn over them. |
| Homogeneity | +++ | + | ++ |
| Covering power | +++ | + | ++ |

Here as well, the applied lead masses were compared in order to demonstrate an objective comparison:

TABLE 4

| | Lead according to the | Leads according to EP | Leads according to EP |
|---|---|---|---|
| | invention | 3 772 532 B1 | 2 520 442 B1 |
| | Initially, red leads 1B were | Initially, red leads | Initially, red leads |
| | applied. Then, blue leads | 2B were applied. Then, | 3B were applied. Then, |
| | 1A were drawn over them. | blue leads 2A were | blue leads 3A were |
| | | drawn over them. | drawn over them. |
| Applied lead mass | 173 mg | 81 mg | 127 mg |

The test showed that significantly more lead mass was applied to the paper with the leads according to the invention than with the leads of the comparative formulations. Due to the significantly higher total lead mass that was applied, it can also be inferred that the covering power of the leads according to the invention is higher than that of the comparative formulations.

In a further test in which blue leads were initially applied and subsequently painted over with the red leads, the result shown in Table 4 could be confirmed.

TABLE 5

| | Lead according to the | Leads according to EP | Leads according to EP |
|---|---|---|---|
| | invention | 3 772 532 B1 | 2 520 442 B1 |
| | Initially, blue leads 1A | Initially, blue leads | Initially, blue leads |
| | were applied. Then, red | 2A were applied. Then, | 3A were applied. Then, |
| | leads 1B were drawn over | red leads 2B were | red leads 3B were |
| | them. | drawn over them. | drawn over them. |
| Applied lead mass | 162 mg | 116 mg | 132 mg |

### MANUFACTURER

1) Wachs-u. Ceresin-Fabriken Th. C. Tromm GmbH, D-50735 Cologne
2) BYK-Chemie GmbH, D 46462 Wesel

1. A colored pencil lead, graphite lead, colored or graphite chalk for painting and/or drawing, having a lead base mass that contains waxes, at least one filler, and at least one colorant, characterized in that
the lead base mass further contains aluminum distearate and, as waxes, at least one functionalized metallocene polyolefin wax and at least one hardened wax.

2. The colored pencil lead, graphite lead, colored or graphite chalk according to claim 1,
characterized in that
the lead base mass contains aluminum distearate at a proportion of 0.4 to 10.0 wt. %.

3. The colored pencil lead, graphite lead, colored or graphite chalk according to claim 1,
characterized in that
the lead base mass contains at least one functionalized metallocene polyolefin wax at a proportion of 5.0 to 25.0 wt. %.

4. The colored pencil lead, graphite lead, colored or graphite chalk according to claim 1,
characterized in that
the at least one functionalized metallocene polyolefin wax has a drop point between 12° and 160° C. and an acid number between 16 and 50 mg KOH/g.

5. The colored pencil lead, graphite lead, colored or graphite chalk according to claim 1,
characterized in that
ethylene-maleic anhydride copolymer (CAS No. 9006-26-2) or propylene-maleic anhydride copolymer (CAS No. 25722-45-6) is contained as functionalized metallocene polyolefin wax.

6. The colored pencil lead, graphite lead, colored or graphite chalk according to claim 1,
characterized in that
the hardened wax has a drop point between 5° and 120° C. (ISO 2176) and an acid number between 1 and 11 mg KOH/g (ISO 2114).

7. The colored pencil lead, graphite lead, colored or graphite chalk according to claim 1,
characterized in that
palm wax, rapeseed wax, sunflower wax, soy wax, ester wax, synthetic beeswax, montan wax, paraffin wax, natural waxes, carnauba wax and/or hydrogenated castor oil and/or hydrogenated vegetable triglycerides having wax-like structures based on the waxes listed are contained as hardened wax.

8. The colored pencil lead, graphite lead, colored or graphite chalk according to claim 1,
characterized in that
the lead base mass contains the hardened wax at a proportion of 2.0 to 30.0 wt. %.

9. The colored pencil lead, graphite lead, colored or graphite chalk according to claim 1,
characterized in that
the lead base mass contains the at least one filler at a proportion of 5.0 to 80 wt. %.

10. The colored pencil lead, graphite lead, colored or graphite chalk according to claim 1,
characterized in that
at least one inorganic filler, in particular talc, pumice powder, kaolin, mica, aluminum silicate, clay and/or calcium carbonate, and/or at least one organic filler, in particular cellulose fibers, wood fibers and/or textile fibers, and/or at least one inorganic pigment, in particular titanium dioxide, zinc oxide and/or barium sulfate, is contained as the filler.

11. The colored pencil lead, graphite lead, colored or graphite chalk according to claim 1,
characterized in that
at least one dye and/or at least one inorganic pigment and/or at least one organic pigment is contained as the colorant in the lead base mass.

12. The colored pencil lead, graphite lead, colored or graphite chalk according to claim 1,
characterized in that
the lead base mass contains the at least one colorant at a proportion of 0.1-50 wt. %, in particular a proportion of 0.1-40 wt. %, particularly preferably a proportion of 0.1-30 wt. %.

13. The colored pencil lead, graphite lead, colored or graphite chalk according to claim 1,
characterized in that
the lead base mass contains at least one additive, in particular a lubricant and/or a dispersing agent.

14. The colored pencil lead, graphite lead, colored or graphite chalk according to claim 13,
characterized in that
the lead base mass contains the additive at a maximum proportion of 5.0 wt. %.
